(19) United States
(12) Patent Application Publication
(10) Pub. No.: US 2026/0005571 A1
(43) Pub. Date: Jan. 1, 2026

(54) STATOR FOR ROTATING ELECTRIC MACHINE

(71) Applicant: KABUSHIKI KAISHA TOYOTA JIDOSHOKKI, Kariya-shi (JP)

(72) Inventors: Hiroyuki OHASHI, Kariya-shi (JP); Kazumasa Kinoshita, Kariya-shi (JP)

(73) Assignee: KABUSHIKI KAISHA TOYOTA JIDOSHOKKI, Kariya-shi (JP)

(21) Appl. No.: 19/245,823

(22) Filed: Jun. 23, 2025

(30) Foreign Application Priority Data
Jun. 28, 2024 (JP) 2024-104706

(51) Int. Cl. H02K 3/52

(52) U.S. Cl. CPC H02K 3/522; H02K 2203/06; H02K 2203/12

(57) ABSTRACT

A stator for a rotating electric machine includes a stator core including a tubular yoke and teeth, coils that are formed by windings wound around the teeth, and insulators. The insulators each include a tubular insulator base. The insulator base includes a first circumferential surface at a first side in the radial direction of the yoke, a second circumferential surface at a second side opposite to the first side in the radial direction, lead-out grooves each of which leads a lead wire of a coil from the first side to the second side in the radial direction, and return grooves each of which returns the lead wire, led out through a lead-out groove, from the second side to the first side in the radial direction. Each lead-out groove holds the lead wire by interference fit. Each return groove holds the lead wire by loose fit.

### CROSS-REFERENCE TO RELATED APPLICATIONS

This application is based upon and claims the benefit of priority from Japanese Patent Application No. 2024-104706, filed on Jun. 28, 2024, the entire contents of which are incorporated herein by reference.

### BACKGROUND

### 1. Field

The present disclosure relates to a stator for a rotating electric machine.

### 2. Description of Related Art

As disclosed, for example, in Japanese Laid-Open Patent Publication No. 2010-259318, a stator for a rotating electric machine includes a stator core, coils, and insulators. The stator core includes a tubular yoke and teeth. The teeth extend in the radial direction of the yoke from a circumferential surface of the yoke. The coils are formed by windings wound around the teeth. The coils include coil ends. The coil ends protrude from core end faces of the stator core in the axial direction of the yoke. The insulators are disposed to face the core end faces. The insulators isolate the coil ends from the core end faces. The insulators each include a tubular insulator base disposed at a position overlapping with the yoke in the axial direction. The insulator base has a first circumferential surface at a first side in the radial direction, at which the coil ends are located, and a second circumferential surface at a second side in the radial direction, opposite to the first side.

Each coil has multiple wound portions formed by a winding wound around the teeth in a concentrated manner. A winding-end lead wire, which is a portion of the winding, is led out from the wound portion. The start of winding of each wound portion is fixed as a result of the winding being wound around the corresponding tooth. This prevents the start of winding of the wound portion from loosening. On the other hand, in order to prevent loosening of the end of winding of the wound portion, it is necessary to fix the winding-end lead wire.

In this regard, the insulator base may include lead-out grooves and return grooves. The lead-out grooved open at an insulator end, which is an end of the insulator base at a side opposite to the stator core. Each lead-out groove has a first end, which opens in the first circumferential surface of the insulator base, and a second end, which opens in the second circumferential surface of the insulator base. The lead-out groove leads the lead wire from the first side to the second side in the radial direction of the insulator base. The return grooves open at the insulator end. Each return groove has a first end, which opens in the first circumferential surface of the insulator base, and a second end, which opens in the second circumferential surface of the insulator base. Each return groove is arranged at a position adjacent to one of the lead-out grooves in the circumferential direction of the insulator base. The return groove returns the lead wire, led out through the lead-out groove, from the second side to the first side in the radial direction of the insulator base.

In this manner, the lead wire is led out to the second side in the radial direction of the insulator base through the lead-out groove and is returned to the first side in the radial direction of the insulator base through the return groove. As a result, the lead wire is wound and fixed to the insulator. This fixes the lead wire to the insulator, preventing the end of winding of the wound portion from loosening.

However, if the lead wire is not held by interference fit in at least one of the lead-out groove and the return groove, the winding and fixing of the lead wire to the insulator is unstable. As a result, there is a risk that the end of winding of the wound portion may loosen. On the other hand, for example, in a case in which the return groove holds the lead wire by interference fit, when the lead wire, led out through the lead-out groove to the second side in the radial direction of the insulator base, is returned to the first side in the radial direction of the insulator base via the return groove, the lead wire may be drawn from the first side in the radial direction of the insulator base, while avoiding interference with other lead wires of the coil ends. In this case, it may be difficult to avoid interference with other lead wires. Consequently, the operation of winding and fixing the lead wire to the insulator becomes complicated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a stator for a rotating electric machine includes a stator core, multiple coils, and an insulator. The stator core includes a tubular yoke and multiple teeth extending in a radial direction of the yoke from a circumferential surface of the yoke. The coils are formed by windings that are wound around the teeth. The coils have coil ends that protrude from a core end face. The core end face is an end face of the stator core in an axial direction of the yoke. The insulator is disposed to face the core end face. The insulator insulates the coil ends and the core end face from each other. Each coil includes a wound portion formed by the winding wound in a concentrated manner around one of the teeth, and a winding-end lead wire that is a portion of the winding led out from the wound portion. The insulator includes a tubular insulator base disposed at a position overlapping with the yoke in the axial direction. The insulator base includes a first circumferential surface at a first side in the radial direction at which the coil ends are located, a second circumferential surface at a second side opposite to the first side in the radial direction, an insulator end that is an end of the insulator base at a side opposite to the stator core, a lead-out groove opening at the insulator end, and a return groove at the insulator end. The lead-out groove has a first end that opens in the first circumferential surface and a second end that opens in the second circumferential surface. The lead-out groove leads the lead wire from the first side to the second side in the radial direction. The return groove has a first end that opens in the first circumferential surface and a second end that opens in the second circumferential surface. The return groove is disposed at a position adjacent to the lead-out groove in a circumferential direction of the insulator base and returning the lead wire, led out through the lead-out groove, from the second side to the first side in the radial direction. The lead-out groove holds the lead wire by an interference fit. The return groove holds the lead wire by a loose fit.

In another general aspect, a stator for a rotating electric machine includes a stator core, multiple coils, and an insulator. The stator core includes a tubular yoke and multiple teeth extending in a radial direction of the yoke from a circumferential surface of the yoke. The coils are formed by windings that are wound around the teeth. The coils have coil ends that protrude from a core end face. The core end face is an end face of the stator core in an axial direction of the yoke. The insulator is disposed to face the core end face. The insulator insulates the coil ends and the core end face from each other. Each coil includes a wound portion formed by the winding wound in a concentrated manner around one of the teeth, and a winding-end lead wire that is a portion of the winding led out from the wound portion. The insulator includes a tubular insulator base disposed at a position overlapping with the yoke in the axial direction. The insulator base includes a first circumferential surface at a first side in the radial direction at which the coil ends are located, a second circumferential surface at a second side opposite to the first side in the radial direction, an insulator end that is an end of the insulator base at a side opposite to the stator core, a lead-out groove opening at the insulator end, and a return groove opening at the insulator end. The lead-out groove has a first end that opens in the first circumferential surface and a second end that opens in the second circumferential surface. The lead-out groove leads the lead wire from the first side to the second side in the radial direction. The return groove has a first end that opens in the first circumferential surface and a second end that opens in the second circumferential surface. The return groove is disposed at a position adjacent to the lead-out groove in a circumferential direction of the insulator base and returning the lead wire, led out through the lead-out groove, from the second side to the first side in the radial direction. The return groove has two return groove forming surfaces located on opposite sides of the lead wire in the circumferential direction. When the return groove is viewed in the axial direction, the two return groove forming surfaces are inclined so as to gradually separate from the lead-out groove as the return groove forming surfaces extend from the second circumferential surface toward the first circumferential surface. A width between the two return groove forming surfaces is smaller than an outer diameter of an original shape of the lead wire.

Other features and aspects will be apparent from the following detailed description, the drawings, and the claims.

### BRIEF DESCRIPTION OF THE DRAWINGS

FIG. 1 is a cross-sectional view of a stator and a rotor of a rotating electric machine according to a first embodiment.

FIG. 2 is an exploded perspective view of a stator core and two insulators of the stator shown in FIG. 1.

FIG. 3 is a perspective view of the stator shown in FIG. 1.

FIG. 4 is another perspective view of the stator shown in FIG. 1.

FIG. 5 is an enlarged side view of a portion of the stator shown in FIG. 1.

FIG. 6 is an enlarged cross-sectional view of a portion of the stator shown in FIG. 1.

FIG. 7 is an explanatory diagram showing an operation of winding and fixing a lead wire of the stator shown in FIG. 1 to an insulator.

FIG. 8 is an explanatory diagram showing the operation of winding and fixing a lead wire of the stator shown in FIG. 1 to an insulator.

FIG. 9 is an explanatory diagram showing the operation of winding and fixing a lead wire of the stator shown in FIG. 1 to an insulator.

FIG. 10 is an explanatory diagram showing the operation of winding and fixing a lead wire of the stator shown in FIG. 1 to an insulator.

FIG. 11 is an enlarged perspective view showing a part of a stator according to a second embodiment.

FIG. 12 is an enlarged front view of the part of the stator shown in FIG. 11.

FIG. 13 is an enlarged side view of a part of a stator according to a modification.

FIG. 14 is an enlarged front view of a part of a stator according to another modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

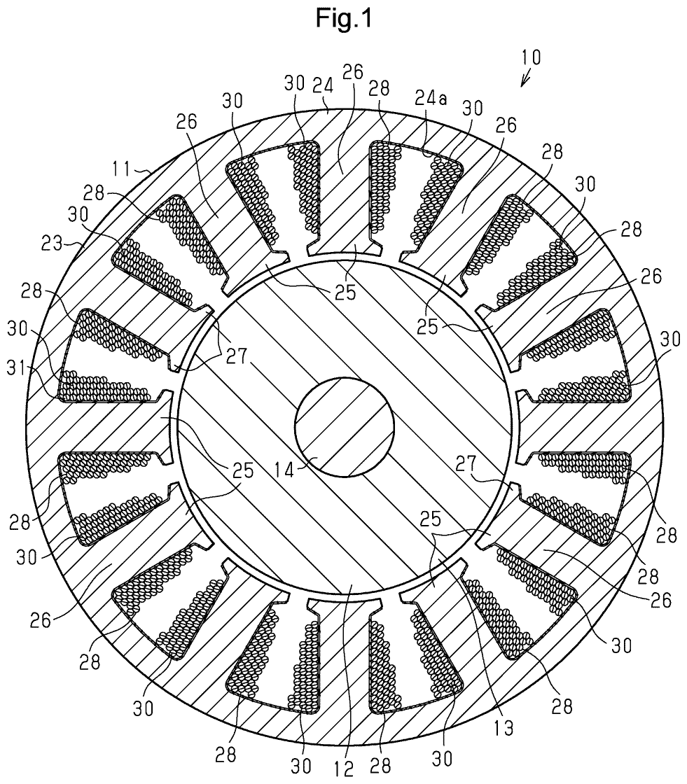

A stator 11 for a rotating electric machine 10 according to a first embodiment will now be described with reference to FIGS. 1 to 10.

### Basic Structure of the Rotating Electric Machine

As shown in FIG. 1, the rotating electric machine 10 includes the stator 11 and a rotor 12. The stator 11 is tubular. The rotor 12 is located on the inner side of the stator 11.

The rotor 12 includes a cylindrical rotor core 13 and permanent magnets (not shown) embedded in the rotor core 13. The rotor core 13 is fixed to a rotary shaft 14. The rotor core 13 is configured to rotate integrally with the rotary shaft 14.

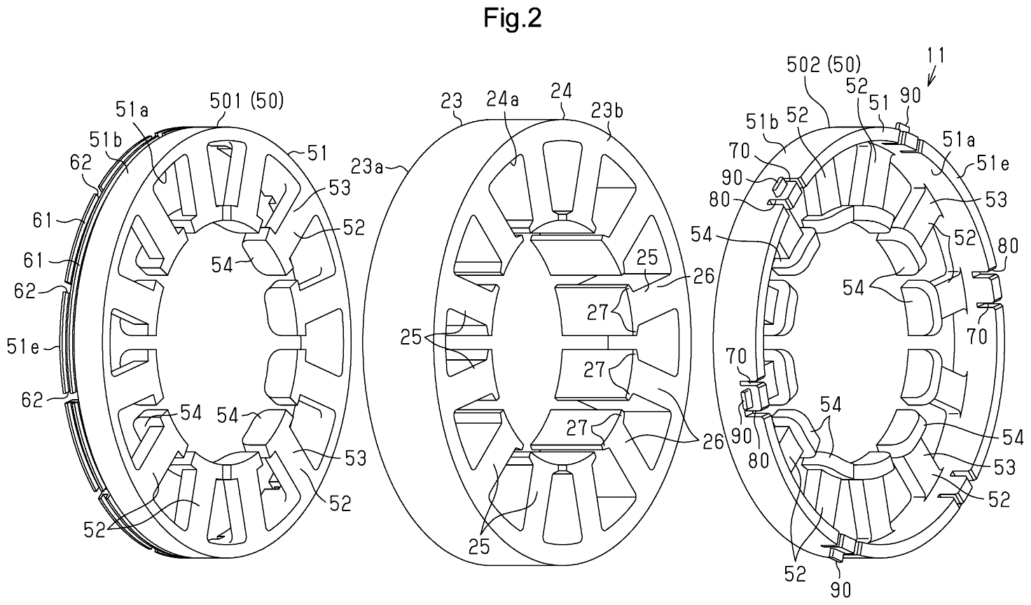

As shown in FIGS. 1 and 2, the stator 11 includes a stator core 23. The stator core 23 includes a yoke 24 and multiple teeth 25. The yoke 24 is cylindrical. The teeth 25 extend in a radial direction of the yoke 24 from an inner circumferential surface 24a, which is a circumferential surface of the yoke 24. The teeth 25 are spaced apart from each other in a circumferential direction of the yoke 24. The teeth 25 are disposed at equal intervals in the circumferential direction of the yoke 24. The circumferential direction of the yoke 24 corresponds to the circumferential direction of the stator core 23. Each tooth 25 extends from the inner circumferential surface 24a of the yoke 24 toward the axis of the stator core 23. In the present embodiment, the stator core 23 includes twelve teeth 25. Although the number of the teeth 25 is not particularly limited, the number of the teeth 25 is a multiple of three.

As shown in FIG. 2, opposite end faces of the yoke 24 in the axial direction are flat. Opposite end faces of each tooth 25 in the axial direction of the yoke 24 are flat. The length of the yoke 24 in the axial direction is equal to the length of each tooth 25 in the axial direction of the yoke 24. An end face of the yoke 24 located at a first side in the axial direction is located on the same plane as an end face of each tooth 25 located at the first side in the axial direction of the yoke 24. An end face of the yoke 24 located at a second side in the axial direction is located on the same plane as an end face of each tooth 25 located at the second side in the axial direction of the yoke 24.

The end face of the yoke 24 located at the first side in the axial direction and the end faces of the teeth 25 located at the first side in the axial direction of the yoke 24 form a first core end face 23a, which is an end face of the stator core 23 located at the first side in the axial direction of the yoke 24. The end face of the yoke 24 located at the second side in the axial direction and the end faces of the teeth 25 located at the second side in the axial direction of the yoke 24 form a second core end face 23b, which is an end face of the stator core 23 located at the second side in the axial direction of the yoke 24. The first core end face 23a and the second core end face 23b are core end faces of the stator core 23 in the axial direction of the yoke 24.

As shown in FIGS. 1 and 2, each tooth 25 includes a tooth extension 26 and two tooth flanges 27. The tooth extension 26 is a thin plate that extends from the inner circumferential surface 24a of the yoke 24. The tooth extension 26 extends from the first core end face 23a to the second core end face 23b of the stator core 23. The tooth flanges 27 project from the end of the tooth extension 26 on the side opposite to the end connected to the yoke 24 and toward the opposite sides in the circumferential direction of the yoke 24.

As shown in FIG. 2, the stator 11 includes two insulators 50. Each insulator 50 is tubular. Each insulator 50 is made of, for example, plastic. Each insulator 50 includes an insulator base 51 and insulator tooth portions 52. The insulator base 51 is cylindrical. The insulators 50 are disposed on the stator core 23 with the axes of the insulator bases 51 agreeing with the axis of the yoke 24. The insulator bases 51 are disposed at positions overlapping with the yoke 24 in the axial direction of the yoke 24. The circumferential direction of each insulator base 51 agrees with the circumferential direction of the yoke 24. The radial direction of each insulator base 51 agrees with the radial direction of the yoke 24. One of the two insulators 50 is disposed to face the first core end face 23a of the stator core 23 while being in contact with the first core end face 23a. The other of the two insulators 50 is disposed to face the second core end face 23b while being in contact with the second core end face 23b of the stator core 23. In the following description, one of the two insulators 50 that is disposed to face the first core end face 23a of the stator core 23 may be referred to as a first insulator 501, and the insulator 50 disposed to face the second core end face 23b may be referred to as a second insulator 502. The outer diameter of the insulator base 51 is smaller than the outer diameter of the yoke 24. The inner diameter of the insulator base 51 is equal to the inner diameter of the yoke 24.

Each insulator tooth portion 52 extends in the radial direction of the insulator base 51 from an inner circumferential surface 51a of the insulator base 51. The insulator tooth portions 52 are spaced apart from each other in the circumferential direction of the insulator base 51. The insulator tooth portions 52 are disposed at equal intervals in the circumferential direction of the insulator base 51. Each insulator tooth portion 52 extends from the inner circumferential surface 51a of the insulator base 51 toward the axis of the insulator base 51. In the present embodiment, each insulator 50 includes twelve insulator tooth portions 52. The number of the insulator tooth portions 52 is the same as the number of the teeth 25 of the stator core 23.

Each insulator tooth portion 52 includes an insulator extension 53 and an insulator flange 54. Each insulator extension 53 has the shape of a post that extends from the inner circumferential surface 51a of the insulator base 51. The width of each insulator extension 53 in the circumferential direction of the insulator base 51 is equal to the width of each tooth extension 26 in the circumferential direction of the yoke 24. Each insulator extension 53 is in contact with the corresponding tooth 25. The insulator flange 54 projects parallel to the insulator base 51 from the end of the insulator extension 53 on the side opposite to the end the connected to the insulator base 51.

Multiple connection wire receiving grooves 61 are formed in an outer circumferential surface 51b of the insulator base 51 of the first insulator 501. The connection wire receiving grooves 61 are arranged side by side in the axial direction of the insulator base 51. Each connection wire receiving groove 61 extends in the circumferential direction of the yoke 24. Each connection wire receiving groove 61 extends over the entire circumference of the outer circumferential surface 51b of the insulator base 51. Each connection wire receiving groove 61 does not extend through the insulator base 51 in the radial direction.

Multiple through-grooves 62 are formed in the insulator base 51 of the first insulator 501. Each through-groove 62 extends through the insulator base 51 in the radial direction. The number of the through-grooves 62 is equal to the number of the teeth 25. Each through-groove 62 extends in the axial direction of the insulator base 51 from an insulator end 51e, which is an end of the insulator base 51 located at the side opposite to the stator core 23.

As shown in FIG. 1, the stator 11 includes three-phase coils 28. Each coil 28 includes multiple wound portions 30. Each wound portion 30 is formed by a winding 31 wound in a concentrated manner so as to collectively surround one of the tooth extensions 26 and the insulator extensions 53 of the corresponding two insulators 50, which are arranged side by side in the axial direction of the stator 11. Thus, each wound portion 30 is formed by a winding 31 wound around a tooth 25 in a concentrated manner.

The winding operation of the winding 31 of the coil 28 of each phase for the tooth extensions 26 and the insulator extensions 53 of the two insulators 50 is automatically performed by, for example, winding equipment including a winding nozzle.

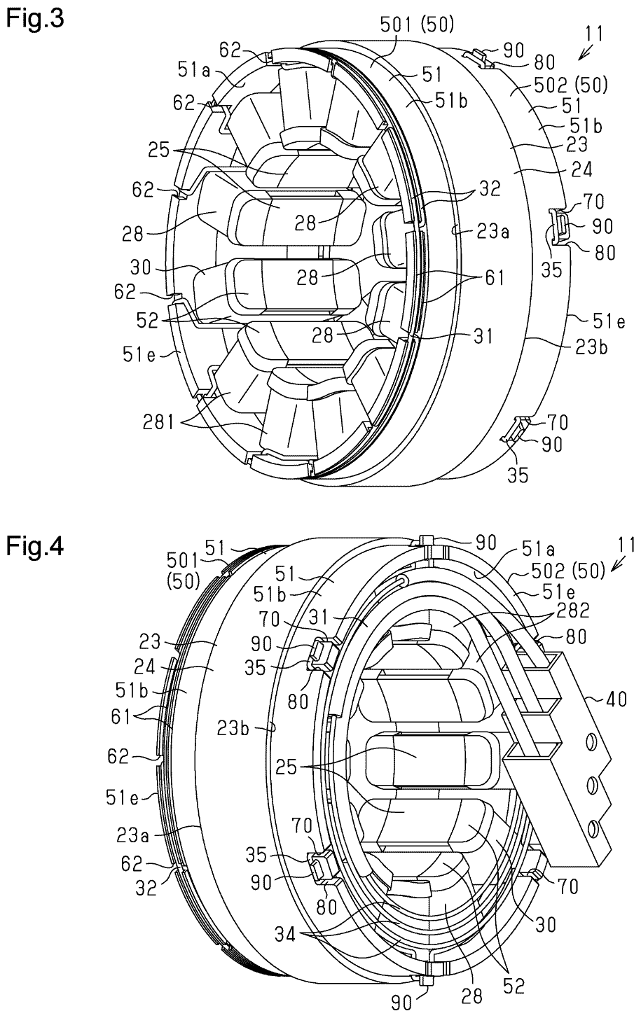

As shown in FIG. 3, a portion of each wound portion 30 is a first coil end 281, which protrudes from the first core end face 23a. The first coil ends 281 are thus coil ends protruding from the first core end face 23a. The first coil ends 281 are parts of the coils 28.

As shown in FIG. 4, a portion of each wound portion 30 is a second coil end 282 that protrudes from the second core end face 23b. The second coil ends 282 are thus coil ends protruding from the second core end face 23b. The second coil ends 282 are parts of the coils 28.

As described above, each coil 28 includes the first coil end 281, which protrudes from the first core end face 23a. Also, each coil 28 includes the second coil end 282, which protrudes from the second core end face 23b. Therefore, each coil 28 includes coil ends that respectively protrude from the core end faces. In this manner, the coils 28 are formed by the windings 31 wound around the respective teeth 25.

As shown in FIG. 3, the first insulator 501 provides insulation between the first coil ends 281 and the first core end face 23a. Accordingly, the first insulator 501 provides insulation between the coils 28 and the first core end face 23a. The inner circumferential surface 51a of the insulator base 51 of the first insulator 501 is a first circumferential surface at a first side in the radial direction of the insulator base 51, at which the first coil ends 281 are located. The outer circumferential surface 51b of the insulator base 51 of the first insulator 501 is a second circumferential surface at a second side opposite to the first side in the radial direction of the insulator base 51.

As shown in FIG. 4, the second insulator 502 provides insulation between the second coil ends 282 and the second core end face 23b. Accordingly, the second insulator 502 provides insulation between the coils 28 and the second core end face 23b. The inner circumferential surface 51a of the insulator base 51 of the second insulator 502 is a first circumferential surface at a first side in the radial direction of the insulator base 51, at which the second coil ends 282 are located. The outer circumferential surface 51b of the insulator base 51 of the second insulator 502 is a second circumferential surface at a second side opposite to the first side in the radial direction of the insulator base 51. In this manner, each insulator base 51 has the first circumferential surface at the first side in the radial direction of the insulator base 51, at which the coil ends are located, and the second circumferential surface at the second side opposite to the first side in the radial direction of the insulator base 51.

As shown in FIG. 3, connection wires 32, which are portions of the windings 31, are led out from the wound portions 30 of the coil 28 of each phase. The connection wires 32 of the coil 28 of each phase are led out from the first coil ends 281. The connection wires 32 of the coil 28 of each phase connect the wound portions 30 forming the coil 28 of that phase in series. Each connection wire 32 is guided in the circumferential direction of the yoke 24 in a state of being received in the connection wire receiving groove 61 via the through-groove 62.

As shown in FIG. 4, a winding-start lead wire 34, which is a portion of each winding 31, is led out from the wound portion 30 of the coil 28 of each phase. The lead wire 34 of the coil 28 of each phase is led out from the second coil end 282. The lead wires 34 of the coils 28 of the respective phases are electrically connected to connection terminals (not shown) accommodated in a cluster block 40. Power from an external power supply is supplied to the lead wires 34 of the coils 28 of the respective phases via connection terminals.

The power from the external power supply is input to the lead wires 34 of the three-phase coils 28. In this manner, when power is input to the three-phase coils 28, the rotor 12 and the rotary shaft 14 rotate integrally.

A winding-end lead wire 35, which is a portion of each winding 31, is led out from the wound portion 30 of the coil 28 of each phase. The lead wires 35 of the coil 28 of each phase are led out from the second coil ends 282. The lead wires 35 of the three-phase coils 28 are electrically connected to one another to form neutral points.

### Lead-Out Grooves

The insulator base 51 of the second insulator 502 includes multiple lead-out grooves 70. The lead-out grooves 70 open at the insulator end 51e, which is an end of the insulator base 51 at the side opposite to the stator core 23. The lead-out grooves 70 extend through the insulator base 51 in the radial direction of the yoke 24. The lead-out grooves 70 each have a first end that opens in the inner circumferential surface 51a of the insulator base 51 and a second end that opens in the outer circumferential surface 51b of the insulator base 51. The lead-out grooves 70 lead the lead wires 35 from the first side to the second side in the radial direction of the insulator base 51. In this manner, the lead-out grooves 70 lead the lead wires 35 from the inner side to the outer side in the radial direction of the yoke 24 with respect to the insulator base 51.

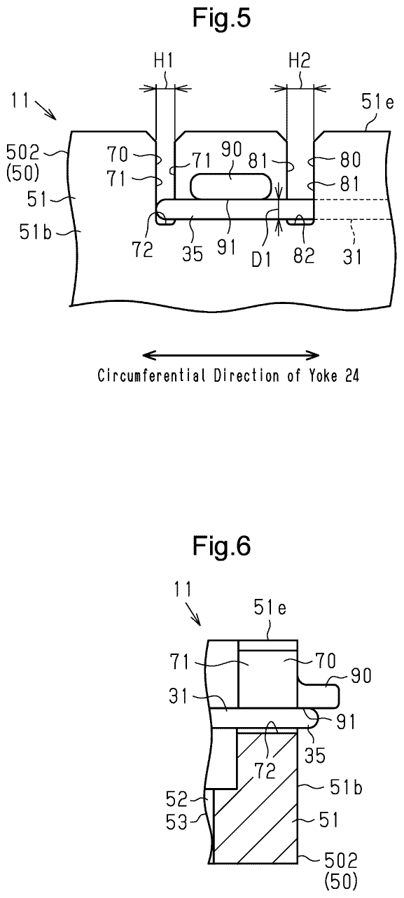

As shown in FIG. 5, each lead-out groove 70 has two lead-out groove forming surfaces 71 and a connection surface 72. When the lead-out groove 70 is viewed in the radial direction of the yoke 24, the two lead-out groove forming surfaces 71 extend from the insulator end 51e in the axial direction of the yoke 24 and extend in parallel with each other. The two lead-out groove forming surfaces 71 are located on the opposite sides of the lead wire 35 in the circumferential direction of the yoke 24. When the lead-out groove 70 is viewed in the axial direction of the yoke 24, the two lead-out groove forming surfaces 71 are linear in the radial direction of the yoke 24 from the outer circumferential surface 51b toward the inner circumferential surface 51a of the insulator base 51. The connection surface 72 connects the ends of the two lead-out groove forming surfaces 71 at the side opposite to the insulator end 51e. When the lead-out groove 70 is viewed in the radial direction of the yoke 24, the connection surface 72 extends in the circumferential direction of the yoke 24.

The width H1 between the two lead-out groove forming surfaces 71 is smaller than the outer diameter D1 of the original shape of the lead wire 35. Therefore, when placed between the two lead-out groove forming surfaces 71, the lead wire 35 is led out from the lead-out groove 70 to the outer side in the radial direction of the yoke 24 with respect to the insulator base 51 in a state of being sandwiched and crushed between the two lead-out groove forming surfaces 71. In this manner, the lead-out groove 70 holds the lead wire 35 by interference fit. The original shape of the lead wire 35 refers to the shape before the lead wire 35 is sandwiched and crushed between the two lead-out groove forming surfaces 71, and to the shape of the lead wire 35 before the lead wire 35 is held in the lead-out groove 70 by interference fit. The width H1 is the shortest distance between the two lead-out groove forming surfaces 71, and is a distance between the two lead-out groove forming surfaces 71 in a direction orthogonal to the radial direction of the yoke 24 in the present embodiment.

### Return Grooves

As shown in FIG. 4, the insulator base 51 of the second insulator 502 includes multiple return grooves 80. The return grooves 80 open at the insulator end 51e. The return grooves 80 extend through the insulator base 51 in the radial direction of the yoke 24. The return grooves 80 each have a first end that opens in the inner circumferential surface 51a of the insulator base 51 and a second end that opens in the outer circumferential surface 51b of the insulator base 51. Each return groove 80 is arranged at a position adjacent to the corresponding lead-out groove 70 in the circumferential direction of the insulator base 51. Each return groove 80 returns the lead wire 35, led out through the corresponding lead-out groove 70, from the second side to the first side in the radial direction of the insulator base 51. In this manner, the return groove 80 returns the lead wire 35, led out through the lead-out groove 70, to the inner side in the radial direction of the yoke 24 with respect to the insulator base 51.

As shown in FIG. 5, each return groove 80 has two return groove forming surfaces 81 and a connection surface 82. When the return groove 80 is viewed in the radial direction of the yoke 24, the two return groove forming surfaces 81 extend from the insulator end 51e in the axial direction of the yoke 24 and extend in parallel with each other. The two return groove forming surfaces 81 are located on the opposite sides of the lead wire 35 in the circumferential direction of the yoke 24. When the return groove 80 is viewed in the axial direction of the yoke 24, the two return groove forming surfaces 81 are linear in the radial direction of the yoke 24 from the outer circumferential surface 51b toward the inner circumferential surface 51a of the insulator base 51. The connection surface 82 connects the ends of the two return groove forming surfaces 81 at the side opposite to the insulator end 51e. When the return groove 80 is viewed in the radial direction of the yoke 24, the connection surface 82 extends in the circumferential direction of the yoke 24.

The distance from the insulator end 51e to the connection surface 82 along each return groove forming surface 81 is the same as the distance from the insulator end 51e to the connection surface 72 along each lead-out groove forming surface 71. The connection surface 82 of each return groove 80 is adjacent to the connection surface 72 of the corresponding lead-out groove 70 in the circumferential direction of the yoke 24.

The width H2 between the two return groove forming surfaces 81 is larger than the outer diameter D1 of the original shape of the lead wire 35. Therefore, when placed between the two return groove forming surfaces 81, the lead wire 35 is returned from the return groove 80 to the inner side in the radial direction of the yoke 24 with respect to the insulator base 51 in a state of being sandwiched between the two return groove forming surfaces 81 without being crushed. In this manner, the return groove 80 holds the lead wire 35 by loose fit. The width H2 is the shortest distance between the two return groove forming surfaces 81, and is a distance between the two return groove forming surfaces 81 in a direction orthogonal to the radial direction of the yoke 24 in the present embodiment.

### Projections

As shown in FIG. 4, the insulator base 51 of the second insulator 502 includes multiple projections 90. Each projection 90 projects from a portion of the outer circumferential surface 51b of the insulator base 51 between a lead-out groove 70 and a return groove 80.

As shown in FIGS. 5 and 6, the projection 90 has a hook surface 91, which is a portion at the side opposite to the insulator end 51e. The hook surface 91 extends in the radial direction of the yoke 24 from the outer circumferential surface 51b of the insulator base 51. The hook surface 91 is a flat surface. The hook surface 91 is disposed closer to the insulator end 51e than the connection surface 72 of the lead-out groove 70 and the connection surface 82 of the return groove 80 are.

The lead wire 35, led out through the lead-out groove 70, extends toward the return groove 80 while being hooked to the hook surface 91 of the projection 90. In this manner, the lead wire 35, led out through the lead-out groove 70, is hooked to a portion of the projection 90 at a side opposite to the insulator end 51e.

### Operation of the First Embodiment

Next, operation of the first embodiment will be described while describing a procedure for winding and fixing the lead wire 35 to the insulator 50.

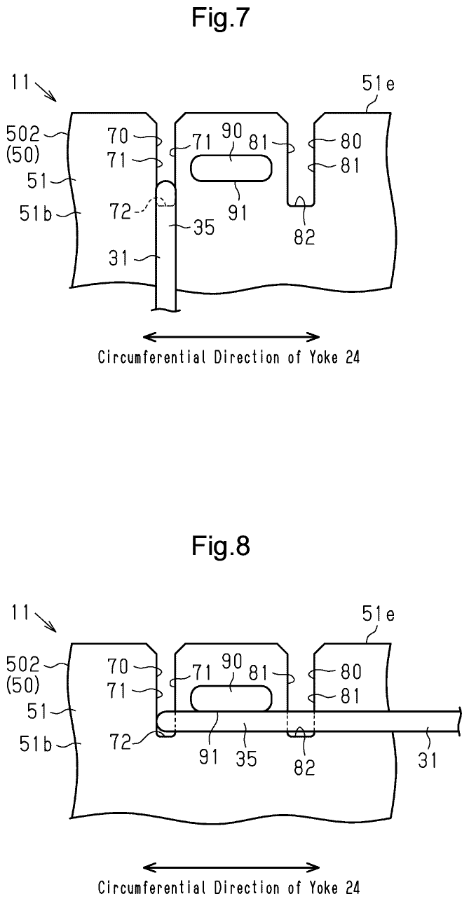

As shown in FIG. 7, when the lead wire 35 is wound and fixed to the insulator 50, first, the lead wire 35 is led out from the lead-out groove 70 to the outer side in the radial direction of the yoke 24 with respect to the insulator base 51 such that the lead wire 35 extends through the lead-out groove 70. At this time, the lead-out groove 70 holds the lead wire 35 by interference fit. The lead wire 35 is thus prevented from being removed from the lead-out groove 70.

Subsequently, as shown in FIG. 8, the lead wire 35, led out through the lead-out groove 70, is bent in the circumferential direction of the yoke 24 toward the return groove 80. At this time, the lead wire 35 is bent in the circumferential direction of the yoke 24 so that the lead wire 35 is hooked to the hook surface 91 of the projection 90.

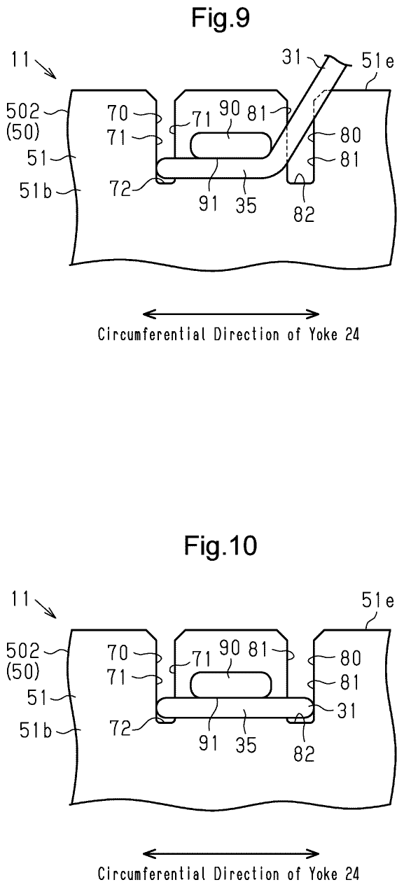

Subsequently, as shown in FIG. 9, the lead wire 35 is bent in the axial direction of the yoke 24 toward the insulator end 51e at a point in the portion hooked to the projection 90. At this time, the lead wire 35 is bent until the portion of the lead wire 35, on the opposite side of the portion hooked to the projection 90 from the lead-out groove 70, partially overlaps with the return groove 80 in the radial direction of the yoke 24.

Subsequently, as shown in FIG. 10, the lead wire 35 is bent inward in the radial direction of the yoke 24 so that the lead wire 35 extends through the return groove 80. At this time, the return groove 80 holds the lead wire 35 by loose fit. This allows the lead wire 35 to readily extend through the return groove 80. In addition, when the lead wire 35 is drawn from the first side in the radial direction while avoiding interference with other lead wires 35 at the second coil ends 282, in order to return the lead wire 35 to the first side in the radial direction of the insulator base 51 through the return groove 80, interference with other lead wires 35 is readily avoided.

Subsequently, as shown in FIG. 5, the lead wire 35, which has been returned to the inner side in the radial direction of the yoke 24 with respect to the insulator base 51 via the return groove 80, is bent to the side opposite to the lead-out groove 70 in the circumferential direction of the yoke 24 on the inner side of the insulator base 51. Accordingly, the lead wire 35, which has been returned to the inner side in the radial direction of the yoke 24 with respect to the insulator base 51 via the return groove 80, extends along the inner circumferential surface 51a of the insulator base 51. Accordingly, interference between the lead wire 35 and a component located on the outer side of the insulator base 51 in the radial direction of the yoke 24 is prevented.

In this manner, the lead wire 35 is wound and fixed to the insulator 50. The lead wire 35 is fixed to the insulator 50 in a state in which tension is applied to the lead wire 35 by being wound and fixed to the insulator 50.

The start of winding of each wound portion 30 of the coils 28 is fixed as a result of the winding 31 being wound around the corresponding tooth 25. This prevents the start of winding of the wound portion 30 from loosening. In addition, since the lead wire 35 is wound and fixed to the insulator 50, loosening of the end of winding of the wound portion 30 is prevented.

### Advantages of the First Embodiment

The first embodiment has the following advantages.

(1-1) Since the lead wire 35 is held in the lead-out groove 70 by interference fit, the winding and fixing of the lead wire 35 to the insulator 50 is prevented from being unstable. Further, since the lead wire 35 is held in the return groove 80 by loose fit, the lead wire 35, led from the lead-out groove 70 to the second side in the radial direction of the insulator base 51, is readily returned to the first side in the radial direction of the insulator base 51 via the return groove 80. Therefore, when the lead wire 35 is drawn from the first side in the radial direction of the insulator base 51 while avoiding interference with other lead wires 35 at the second coil ends 282, in order to return the lead wire 35 to the first side in the radial direction of the insulator base 51 through the return groove 80, interference with other lead wires 35 is readily avoided. This facilitates the operation of winding and fixing the lead wire 35 to the insulator 50. As described above, it is possible to reliably perform the operation of winding and fixing the lead wire 35 to the insulator 50 while preventing the winding and fixing of the lead wire 35 to the insulator 50 from becoming unstable.

(1-2) The width H2 between the two return groove forming surfaces 81 is larger than the outer diameter D1 of the original shape of the lead wire 35. Accordingly, the return groove 80 holds the lead wire 35 by loose fit. Further, the two return groove forming surfaces 81 extend in the axial direction of the yoke 24 from the insulator end 51e and extend parallel with each other. This configuration is suitable for the return groove 80 to hold the lead wire 35 by loose fit.

(1-3) The width H1 between the two lead-out groove forming surfaces 71 is smaller than the outer diameter D1 of the original shape of the lead wire 35. Accordingly, the lead-out groove 70 holds the lead wire 35 by interference fit. Further, the two lead-out groove forming surfaces 71 extend in the axial direction of the yoke 24 from the insulator end 51e and extend parallel with each other. This configuration is suitable for the lead-out groove 70 to hold the lead wire 35 by interference fit.

(1-4) The lead wire 35, led out from the lead-out groove 70 to the second side in the radial direction of the insulator base 51, is hooked to a portion of the projection 90 on the side opposite to the insulator end 51e. Therefore, it is possible to further stabilize the winding and fixing of the lead wire 35 to the insulator 50.

(1-5) For example, a case will now be considered in which the insulator 50 is thermally expanded. In this case, even if the lead-out groove 70 holds the lead wire 35 by interference fit, the stress acting on the lead wire 35 from the insulator 50 is alleviated since the return groove 80 holds the lead wire 35 by loose fit. Therefore, since the durability of the lead wire 35 is improved, the reliability of the stator 11 of the rotating electric machine 10 is improved.

### Second Embodiment

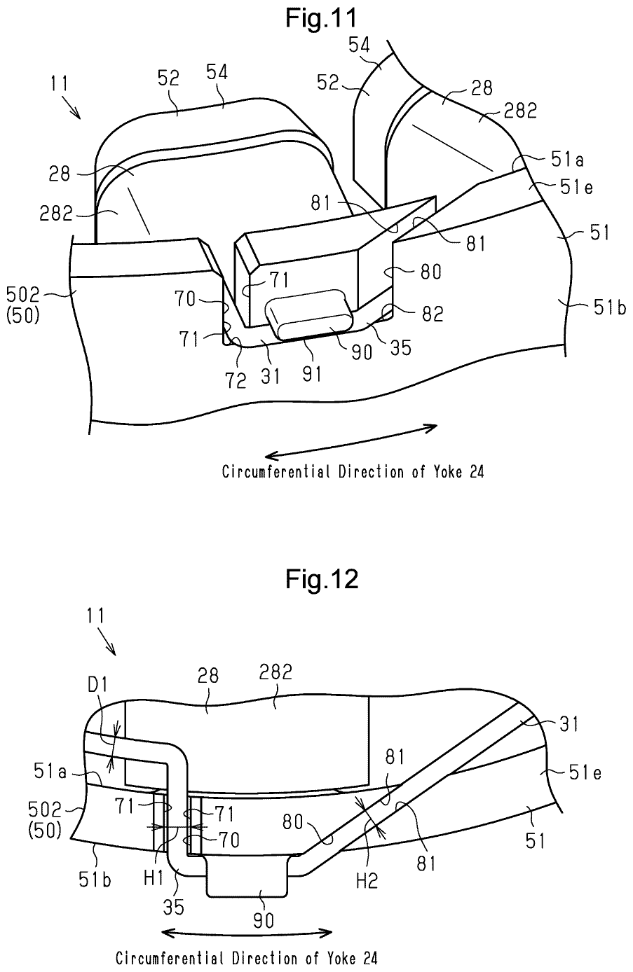

A stator 11 for a rotating electric machine 10 according to a second embodiment will now be described with reference to FIGS. 11 and 12. In the embodiment described below, the same reference numerals are given to those components that are the same as the corresponding components of the first embodiment, which has already been described, and explanations are omitted or simplified.

As shown in FIGS. 11 and 12, when the return groove 80 is viewed in the axial direction of the yoke 24, the two return groove forming surfaces 81 are inclined so as to gradually separate from the lead-out groove 70 as the return groove forming surfaces 81 extend from the outer circumferential surface 51b toward the inner circumferential surface 51a of the insulator base 51. The return groove forming surfaces 81 extend in parallel with each other. The return groove forming surfaces 81 guide the lead wire 35 in a direction away from the lead-out groove 70 when the lead wire 35, led out from the lead-out groove 70 to the second side in the radial direction of the insulator base 51, is returned to the first side in the radial direction of the insulator base 51 through the return groove 80.

As shown in FIG. 12, the width H2 between the two return groove forming surfaces 81 is smaller than the outer diameter D1 of the original shape of the lead wire 35. Therefore, the return groove 80 holds the lead wire 35 by interference fit. The original shape of the lead wire 35 refers to the shape before the lead wire 35 is sandwiched and crushed between the two return groove forming surfaces 81, and to the shape of the lead wire 35 before the lead wire 35 is held in the return groove 80 by interference fit. The width H2 is the shortest distance between the two return groove forming surfaces 81, and is a distance between the two return groove forming surfaces 81 in a direction oblique to the radial direction of the yoke 24 in the present embodiment.

The width H1 between the two lead-out groove forming surfaces 71 is larger than the outer diameter D1 of the original shape of the lead wire 35. Therefore, the lead-out groove 70 holds the lead wire 35 by loose fit.

### Advantages of the Second Embodiment

The second embodiment has the following advantages.

(2-1) The width H2 between the two return groove forming surfaces 81 is smaller than the outer diameter D1 of the original shape of the lead wire 35. The return groove 80 thus holds the lead wire 35 by interference fit. Therefore, the winding and fixing of the lead wire 35 to the insulator 50 is prevented from being unstable. Also, when the return groove 80 is viewed in the axial direction of the yoke 24, the two return groove forming surfaces 81 are inclined so as to gradually separate from the lead-out groove 70 as the return groove forming surfaces 81 extend from the outer circumferential surface 51b toward the inner circumferential surface 51a of the insulator base 51. For example, the two return groove forming surfaces 81 may extend while maintaining an equal distance from the lead-out groove 70 from the outer circumferential surface 51b to the inner circumferential surface 51a of the insulator base 51. Compared to this case, the lead wire 35, led from the lead-out groove 70 to the second side in the radial direction of the insulator base 51, is readily returned to the first side in the radial direction of the insulator base 51 via the return groove 80. Therefore, when the lead wire 35 is drawn from the first side in the radial direction of the insulator base 51 while avoiding interference with other lead wires 35 at the second coil ends 282, in order to return the lead wire 35 to the first side in the radial direction of the insulator base 51 through the return groove 80, interference with other lead wires 35 is readily avoided. This facilitates the operation of winding and fixing the lead wire 35 to the insulator 50. As described above, it is possible to reliably perform the operation of winding and fixing the lead wire 35 to the insulator 50 while preventing the winding and fixing of the lead wire 35 to the insulator 50 from becoming unstable.

(2-2) The width H1 between the two lead-out groove forming surfaces 71 is larger than the outer diameter D1 of the original shape of the lead wire 35. Accordingly, the lead-out groove 70 holds the lead wire 35 by loose fit. For example, a case will now be considered in which the insulator 50 is thermally expanded. In this case, even if the return groove 80 holds the lead wire 35 by interference fit, the stress acting on the lead wire 35 from the insulator 50 is alleviated since the lead-out groove 70 holds the lead wire 35 by loose fit. Therefore, since the durability of the lead wire 35 is improved, the reliability of the stator 11 of the rotating electric machine 10 is improved.

(2-3) When the return groove 80 is viewed in the axial direction of the yoke 24, the two return groove forming surfaces 81 are inclined so as to gradually separate from the lead-out groove 70 as the return groove forming surfaces 81 extend from the outer circumferential surface 51b toward the inner circumferential surface 51a of the insulator base 51. Therefore, when the lead wire 35 is returned to the first side in the radial direction of the insulator base 51 via the return groove 80, the winding equipment can be disposed outside the insulator base 51 in the radial direction of the yoke 24. Accordingly, it is possible to avoid problems such as interference with the lead wires 35 of the coils 28 of other phases, which could occur if the winding equipment were arranged on the inner side of the insulator base 51 in the radial direction of the yoke 24.

### Modifications

The above-described embodiments may be modified as described below. Each of the above embodiments and the following modifications can be combined as long as the combined modifications remain technically consistent with each other.

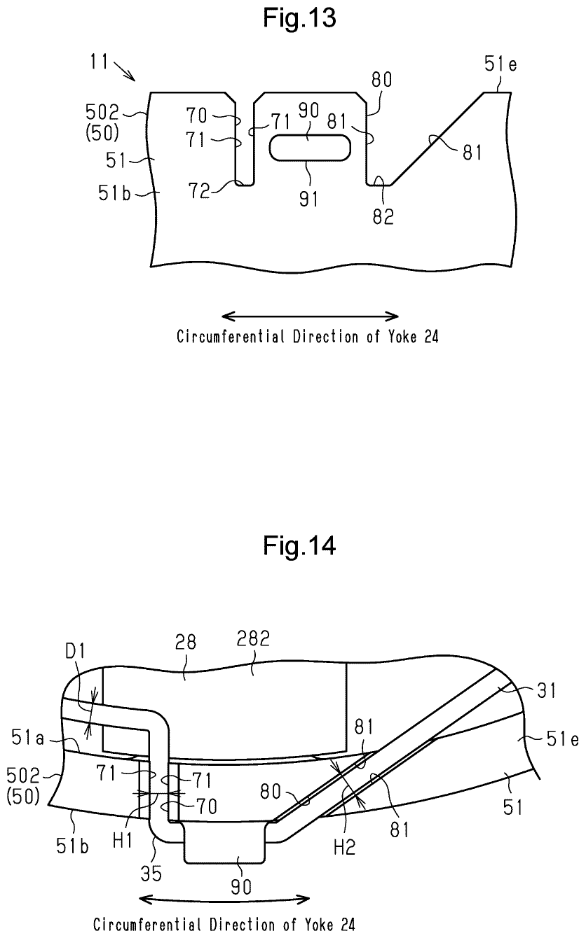

FIG. 13 shows a modification of the first embodiment. As shown in FIG. 13, when the return groove 80 is viewed in the radial direction of the yoke 24, one of the two return groove forming surfaces 81 that is disposed at a position farther from the lead-out groove 70 has an inclined shape that gradually separates from the lead-out groove 70 as it extends toward the insulator end 51e from the connection surface 82, which is the bottom surface of the return groove 80.

With this configuration, when the lead wire 35, led from the lead-out groove 70 to the second side in the radial direction of the insulator base 51, is returned to the first side in the radial direction of the insulator base 51 through the return groove 80, the lead wire 35 is readily allowed to extend through the return groove 80. This further facilitates the operation of winding and fixing the lead wire 35 to the insulator 50. Also, when the lead wire 35 is returned to the first side in the radial direction of the insulator base 51 via the return groove 80, the winding equipment can be disposed outside the insulator base 51 in the radial direction of the yoke 24. Accordingly, it is possible to avoid problems such as interference with the lead wires 35 of the coils 28 of other phases, which could occur if the winding equipment were arranged on the inner side of the insulator base 51 in the radial direction of the yoke 24.

FIG. 14 shows a modification of the first embodiment. As shown in FIG. 14, when the return groove 80 is viewed in the axial direction of the yoke 24, the two return groove forming surfaces 81 are inclined so as to gradually separate from the lead-out groove 70 as the return groove forming surfaces 81 extend from the outer circumferential surface 51b toward the inner circumferential surface 51a of the insulator base 51. The width H2 between the two return groove forming surfaces 81 is larger than the outer diameter D1 of the original shape of the lead wire 35.

According to this configuration, the return groove 80 holds the lead wire 35 by loose fit. When the return groove 80 is viewed in the axial direction of the yoke 24, the two return groove forming surfaces 81 are inclined so as to gradually separate from the lead-out groove 70 as the return groove forming surfaces 81 extend from the outer circumferential surface 51b toward the inner circumferential surface 51a of the insulator base 51. For example, the two return groove forming surfaces 81 may extend while maintaining an equal distance from the lead-out groove 70 from the outer circumferential surface 51b to the inner circumferential surface 51a of the insulator base 51. Compared to this case, the lead wire 35, led from the lead-out groove 70 to the second side in the radial direction of the insulator base 51, is readily returned to the first side in the radial direction of the insulator base 51 via the return groove 80. This further facilitates the operation of winding and fixing the lead wire 35 to the insulator 50.

In the second embodiment, the width H1 between the two lead-out groove forming surfaces 71 may be smaller than the outer diameter D1 of the original shape of the lead wire 35. In other words, in the second embodiment, the lead-out groove 70 may hold the lead wire 35 by interference fit.

In each of the above-described embodiments, the insulator base 51 does not necessarily need to include the projection 90.

In each of the above-described embodiments, the winding-end lead wires 35, which are led out from wound portions 30, are electrically connected to each other to form a neutral point. However, the present disclosure is not limited to this. For example, the winding-end lead wire 35, which is led out from the wound portion 30, may be electrically connected to an external power supply via a connection terminal accommodated in the cluster block 40. In this case, winding-start portions of the windings that are led out from the wound portions 30 are electrically connected to each other to form a neutral point.

In each of the above-described embodiments, the rotor 12 is disposed inside the stator 11, but the stator 11 may be disposed inside the tubular rotor 12. In this case, the teeth 25 extend outward in the radial direction of the yoke 24 from the outer circumferential surface, which is a circumferential surface of the yoke 24. It is sufficient that the teeth 25 extend in the radial direction of the yoke 24 from a circumferential surface of the yoke 24. When the stator 11 is disposed inside the rotor 12, the outer circumferential surface 51b of the insulator base 51 is a first circumferential surface at the first side in the radial direction of the yoke 24 (insulator base 51), at which a coil end is located, and the inner circumferential surface 51a of the insulator base 51 is a second circumferential surface at the second side opposite to the first side in the radial direction of the yoke 24 (insulator base 51).

In each of the above-described embodiments, the winding operation for the tooth extension 26 and the insulator extensions 53 of the two insulators 50 in the winding 31 of the coil 28 of each phase may be performed manually.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A stator for a rotating electric machine, the stator comprising:
a stator core including a tubular yoke and multiple teeth extending in a radial direction of the yoke from a circumferential surface of the yoke;
multiple coils formed by windings that are wound around the teeth, the coils having coil ends that protrude from a core end face, the core end face being an end face of the stator core in an axial direction of the yoke; and
an insulator disposed to face the core end face, the insulator insulating the coil ends and the core end face from each other, wherein
each coil includes:
a wound portion formed by the winding wound in a concentrated manner around one of the teeth; and
a winding-end lead wire that is a portion of the winding led out from the wound portion,
the insulator includes a tubular insulator base disposed at a position overlapping with the yoke in the axial direction,
the insulator base includes:
a first circumferential surface at a first side in the radial direction at which the coil ends are located;
a second circumferential surface at a second side opposite to the first side in the radial direction;
an insulator end that is an end of the insulator base at a side opposite to the stator core;
a lead-out groove opening at the insulator end, the lead-out groove having a first end that opens in the first circumferential surface and a second end that opens in the second circumferential surface, the lead-out groove leading the lead wire from the first side to the second side in the radial direction; and
a return groove opening at the insulator end, the return groove having a first end that opens in the first circumferential surface and a second end that opens in the second circumferential surface, the return groove being disposed at a position adjacent to the lead-out groove in a circumferential direction of the insulator base and returning the lead wire, led out through the lead-out groove, from the second side to the first side in the radial direction,
the lead-out groove holds the lead wire by an interference fit, and
the return groove holds the lead wire by a loose fit.

2. The stator for the rotating electric machine according to claim 1, wherein
the return groove has two return groove forming surfaces located on opposite sides of the lead wire in the circumferential direction,
the two return groove forming surfaces extend in the axial direction from the insulator end and extend parallel with each other, and
a width between the two return groove forming surfaces is larger than an outer diameter of an original shape of the lead wire.

3. The stator for the rotating electric machine according to claim 1, wherein
the return groove has two return groove forming surfaces located on opposite sides of the lead wire in the circumferential direction, and
one of the two return groove forming surfaces that is disposed at a position farther from the lead-out groove is inclined so as to gradually separate from the lead-out groove as the one of the return groove forming surfaces extends toward the insulator end.

4. The stator for the rotating electric machine according to claim 1, wherein
the return groove has two return groove forming surfaces located on opposite sides of the lead wire in the circumferential direction,
when the return groove is viewed in the axial direction, the two return groove forming surfaces are inclined so as to gradually separate from the lead-out groove as the return groove forming surfaces extend from the second circumferential surface toward the first circumferential surface, and
a width between the two return groove forming surfaces is larger than an outer diameter of an original shape of the lead wire.

5. The stator for the rotating electric machine according to claim 1, wherein
the lead-out groove has two lead-out groove forming surfaces located on opposite sides of the lead wire in the circumferential direction,
the two lead-out groove forming surfaces extend in the axial direction from the insulator end and extend parallel with each other, and
a width between the two lead-out groove forming surfaces is smaller than an outer diameter of an original shape of the lead wire.

6. The stator for the rotating electric machine according to claim 1, wherein
the insulator base includes a projection projecting from a portion of the second circumferential surface between the lead-out groove and the return groove, and
the lead wire, led out through the lead-out groove, is hooked to a portion of the projection on a side opposite to the insulator end.

7. A stator for a rotating electric machine, the stator comprising:
a stator core including a tubular yoke and multiple teeth extending in a radial direction of the yoke from a circumferential surface of the yoke;
multiple coils formed by windings that are wound around the teeth, the coils having coil ends that protrude from a core end face, the core end face being an end face of the stator core in an axial direction of the yoke; and
an insulator disposed to face the core end face, the insulator insulating the coil ends and the core end face from each other, wherein
each coil includes:
a wound portion formed by the winding wound in a concentrated manner around one of the teeth; and
a winding-end lead wire that is a portion of the winding led out from the wound portion,
the insulator includes a tubular insulator base disposed at a position overlapping with the yoke in the axial direction,
the insulator base includes:
a first circumferential surface at a first side in the radial direction at which the coil ends are located;
a second circumferential surface at a second side opposite to the first side in the radial direction;
an insulator end that is an end of the insulator base at a side opposite to the stator core;
a lead-out groove opening at the insulator end, the lead-out groove having a first end that opens in the first circumferential surface and a second end that opens in the second circumferential surface, the lead-out groove leading the lead wire from the first side to the second side in the radial direction; and
a return groove opening at the insulator end, the return groove having a first end that opens in the first circumferential surface and a second end that opens in the second circumferential surface, the return groove being disposed at a position adjacent to the lead-out groove in a circumferential direction of the insulator base and returning the lead wire, led out through the lead-out groove, from the second side to the first side in the radial direction,
the return groove has two return groove forming surfaces located on opposite sides of the lead wire in the circumferential direction,
when the return groove is viewed in the axial direction, the two return groove forming surfaces are inclined so as to gradually separate from the lead-out groove as the return groove forming surfaces extend from the second circumferential surface toward the first circumferential surface, and
a width between the two return groove forming surfaces is smaller than an outer diameter of an original shape of the lead wire.

8. The stator for the rotating electric machine according to claim 7, wherein
the lead-out groove has two lead-out groove forming surfaces located on opposite sides of the lead wire in the circumferential direction, and
a width between the two lead-out groove forming surfaces is larger than an outer diameter of an original shape of the lead wire.

9. The stator for the rotating electric machine according to claim to 7, wherein
the insulator base includes a projection projecting from a portion of the second circumferential surface between the lead-out groove and the return groove, and
the lead wire, led out through the lead-out groove, is hooked to a portion of the projection on a side opposite to the insulator end.
